(19) United States
(12) Patent Application Publication
(10) Pub. No.: US 2014/0151292 A1
(43) Pub. Date: Jun. 5, 2014

(54) STACKABLE ACOUSTIC TREATMENT MODULE

(71) Applicant: Lee Hong Ng, Palo Alto, CA (US)

(72) Inventor: Lee Hong Ng, Palo Alto, CA (US)

(73) Assignee: SIEMENS CORPORATION, Iselin, NJ (US)

(21) Appl. No.: 13/898,660

(22) Filed: May 21, 2013

Related U.S. Application Data
(60) Provisional application No. 61/651,253, filed on May 24, 2012.

(51) Int. Cl. C02F 1/36

(52) U.S. Cl. CPC C02F 1/36
USPC 210/523

(57) ABSTRACT

An acoustic treatment module stack includes a plurality of stacked pipe segments. Each pipe segment includes n ultrasound amplifier-transducers with an angular separation of (360/n)° on an outer circumference of the pipe segment, in which n is a positive integer, and a reflector unit disposed in a center of the pipe segment that includes n reflectors in which each ultrasound amplifier-transducer has a corresponding reflector positioned opposite of the ultrasound amplifier-transducer. Each acoustic treatment module is rotated (360/(n×m))° with respect to a preceding acoustic treatment module, in which m is a positive integer, and the plurality of acoustic treatment modules includes at least m pipe segments.

### CROSS REFERENCE TO RELATED UNITED STATES APPLICATIONS

This application claims priority from “SATM: Stackable Acoustic Treatment Module”, U.S. Provisional Application No. 61/651,253 of Lee Hong Ng, filed May 24, 2012, the contents of which are herein incorporated by reference in their entirety.

### TECHNICAL FIELD

This application is directed to the use of ultrasonic standing waves for inducing agglomeration or coalescence of micron-sized liquid or particle suspensions in a host fluid.

### DISCUSSION OF THE RELATED ART

The separation of micron sized solid particles or liquid droplets from their suspending or immiscible fluid is important to a wide range of biological, material, and chemical applications. Conventional separation methods for suspensions in liquid include: (1) Physical screening techniques that separate based on size, such as mechanical sieves, beds of filtration media, and filter membranes; (2) Gravity-driven methods that separate based on density differences, such as settling and flotation; and (3) External fields to separate based on electromagnetic characteristics, such as such as magnetic and centrifugal forces.

However, these conventional separation techniques become problematic when dealing with particles that are small in size, have neutral buoyancy, or uniform electromagnetic characteristics. An innovative external field technique that uses ultrasonic fields addresses these issues by exploiting the density and compressibility differences between the dispersed and continuous phase.

In the past few decades, the use of ultrasonic standing wave fields for the separation of a dispersed phase from their host liquid has developed. Suspended particles respond to the resonant acoustic field if there is a non-zero acoustic contrast between the dispersed phase and the suspending fluid. The acoustic contrast factor of a particle when particle size is less than the acoustic wavelength is based on the density and longitudinal sound speed differences between the particle and the suspending fluid. The acoustic contrast factor, φ, which describes the relationship between the densities and compressibilities of two media, can be expressed as

$$φ = \frac{5 {ρ}_{p} - 2 ρ}{2 {ρ}_{p} + ρ} - \frac{{β}_{p}}{β} ,$$

where β, βₚ, ρ, ρₚ are the respective compressibilities and densities of the medium and particle. For a positive value of φ, the particles will be attracted to the pressure nodes, and vice versa.

When acoustic energy is applied to a fluid-filled chamber below cavitation level, it is possible to generate a standing wave consisting of nodes and antinodes. The net force will drive particles with a positive or negative acoustic factor to the pressure nodes or antinodes, respectively, allowing for particle agglomeration or coalescence. This enlargement in particle or drop size allows for an increased ease of separation in subsequent steps.

Numerous methods exist in the literature that utilizes acoustic standing waves in the separation of dispersed phases from their suspending fluid. In some methods, a one-dimensional sound field is used to collect particles into parallel bands separated by one-half acoustic wavelength. Particles can then be separated from their host liquid in a variety of ways. One model that simultaneously applies ultrasound with electrolysis for the removal of soap-encircled-grease micelles that are suspended in water from washing raw wool uses a standing ultrasonic wave to flocculate micelles while using electrolysis to coalesce micelles. Other methods use a blend of acoustic and physical separation techniques that use a porous medium subject to a standing ultrasonic wave field.

### SUMMARY

Exemplary embodiments of the invention as described herein generally include systems and methods for using ultrasonic standing waves to induce agglomeration or coalescence of micron-sized liquid or particle suspensions in a host fluid. A system according to an embodiment of the disclosure is compact and scalable, and can remove any predefined phase in a solution or emulsion, such as oil in produced water, sludge in wastewater, and pollutants such as silica, metal tidings or other compounds in industrial wastewater, in an in-pipe pretreatment or a primary or tertiary treatment.

According to an aspect of the invention, there is provided an acoustic treatment module that includes a segment of a pipe, a plurality of ultrasound amplifier-transducers symmetrically arranged on an outer circumference of the pipe segment, and a reflector unit disposed in a center of the pipe segment and held in place by a support structure. The ultrasound amplifier-transducers are configured to emit ultrasound into the pipe segment while a fluid mixture is flowing therethrough, and a frequency of the ultrasound is configured to separate and coalesce particles from the fluid mixture.

According to a further aspect of the invention, the reflector unit includes a plurality of reflectors in which each ultrasound amplifier-transducer has a corresponding reflector positioned opposite of the ultrasound amplifier-transducer.

According to a further aspect of the invention, the support structure includes a plurality of support struts in which each ultrasound amplifier-transducer has a corresponding strut that connect the reflector unit to an inside surface of the pipe segment.

According to a further aspect of the invention, the reflector unit includes four reflectors, and the plurality of ultrasound amplifier-transducers includes four ultrasound amplifier-transducers.

According to a further aspect of the invention, the reflector unit has a cross sectional shape of a square.

According to a further aspect of the invention, the reflector unit has a cross sectional shape of a “+” sign.

According to a further aspect of the invention, the reflector unit has a cross sectional shape of an “I”-beam.

According to a further aspect of the invention, the acoustic treatment module includes a plurality of flanges configured to align and tighten sections containing the ultrasound amplifier-transducers.

According to a further aspect of the invention, the acoustic treatment module includes a stack of a plurality of acoustic treatment modules, wherein each acoustic treatment module is rotated with respect to a preceding acoustic treatment module wherein the ultrasound amplifier-transducers of each acoustic treatment module are offset by an angular separation with respect to the preceding acoustic treatment module that is less than an angular separation of the ultrasound amplifier-transducers on the acoustic treatment modules.

According to a further aspect of the invention, each acoustic treatment module includes four ultrasound amplifier-transducers with an angular separation of 90°, and each acoustic treatment module is rotated by 30° with respect to the preceding acoustic treatment module, and the stack of a plurality of acoustic treatment modules includes at least three acoustic treatment modules.

According to another aspect of the invention, there is provided an acoustic treatment module stack that includes a plurality of stacked pipe segments. Each pipe segment includes n ultrasound amplifier-transducers with an angular separation of (360/n)° on an outer circumference of the pipe segment, wherein n is a positive integer; and a reflector unit disposed in a center of the pipe segment that includes n reflectors wherein each ultrasound amplifier-transducer has a corresponding reflector positioned opposite of the ultrasound amplifier-transducer. Each acoustic treatment module is rotated (360/(n×m))° with respect to a preceding acoustic treatment module, wherein m is a positive integer, and the plurality of acoustic treatment modules includes at least m pipe segments.

According to a further aspect of the invention, the reflector unit is held in place by a support structure that includes a plurality of support struts wherein each ultrasound amplifier-transducer has a corresponding strut that connect the reflector unit to an inside surface of the pipe segment.

According to a further aspect of the invention, the reflector unit has a cross sectional shape of a regular, convex, n-sided polygon.

According to a further aspect of the invention, the acoustic treatment module stack includes a plurality of flanges configured to align and tighten the ultrasound amplifier-transducers.

According to a further aspect of the invention, the ultrasound amplifier-transducers are configured to emit ultrasound into each pipe segment while a fluid mixture is flowing therethrough, in which a frequency of the ultrasound is configured to separate and coalesce particles from the fluid mixture.

According to another aspect of the invention, there is provide an acoustic treatment module that includes a segment of a pipe, a plurality of reflectors symmetrically arranged on an outer circumference of the pipe segment, and a plurality of ultrasound amplifier-transducers disposed in a center of the pipe segment and held in place by a support structure, wherein each ultrasound amplifier-transducer is positioned opposite from a reflector. Each ultrasound amplifier-transducer is configured to emit ultrasound into the pipe segment while a fluid mixture is flowing therethrough, in which a frequency of the ultrasound is configured to separate and coalesce particles from the fluid mixture.

According to a further aspect of the invention, acoustic treatment module includes a stack of a plurality of acoustic treatment modules, wherein each acoustic treatment module is rotated with respect to a preceding acoustic treatment module wherein the reflector of each acoustic treatment module are offset by an angular separation with respect to the preceding acoustic treatment module that is less than an angular separation of the reflectors on the acoustic treatment modules.

### BRIEF DESCRIPTION OF THE DRAWINGS

FIGS. 1(a)-(b) are cross-sectional and planar views, respectively, of a stackable acoustic treatment module according to an embodiment of the invention.

FIGS. 2(a)-(c) illustrate the rotation of modules to maximize acoustic field coverage, according to an embodiment of the invention.

### DETAILED DESCRIPTION OF EXEMPLARY EMBODIMENTS

Exemplary embodiments of the invention as described herein generally provide systems and methods for using ultrasonic standing waves to induce agglomeration or coalescence of micron-sized liquid or particle suspensions in a host fluid. While embodiments are susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

Acoustic resonance may be used to hold particles in place for removal. The forces that result from the applied acoustic energy will drive droplets towards the node or antinode planes of the applied alternating acoustic field, depending on the acoustic properties of the dispersed phase. The antinodes are the positions on the standing wave of maximum pressure amplitude, and the nodes are the positions of minimum pressure amplitude. The differences in oscillation amplitude among the droplets will cause the droplets to collide and coalesce. Suspended droplets will migrate towards antinodes or nodes depending on the density and compressibilty of the suspended material.

To achieve separation of oil from wastewater, the acoustic energy must be applied at an intensity and frequency which will prevent cavitation within the fluid, which is the formation, growth, and implosive collapse of microbubbles in a liquid medium. The shock waves from the imploding bubbles may produce high enough shear forces to disperse or emulsify the droplets entrained in the host fluid rather than coalesce. The coalesced hydrocarbons can then be separated from the wastewater using conventional equipment.

The application of acoustic energy can be a pretreatment step to enlarge oil droplet size before the fluid enters a conventional primary, secondary or tertiary treatment separation unit, all of which currently tend to be inefficient for droplets less than about 20 microns in size. Acoustic energy can also be applied as an integral part of a primary or secondary treatment, and can be used with successive treatment units.

A conventional acoustic system typically has a square cross section where the acoustic transducers are typically mounted on one plane while flat surfaces on the opposite planes reflect the acoustic wave. This type of linear system is simple to design and built, and can be scaled up by stacking multiple rectangular sections together to accommodate higher flow rate.

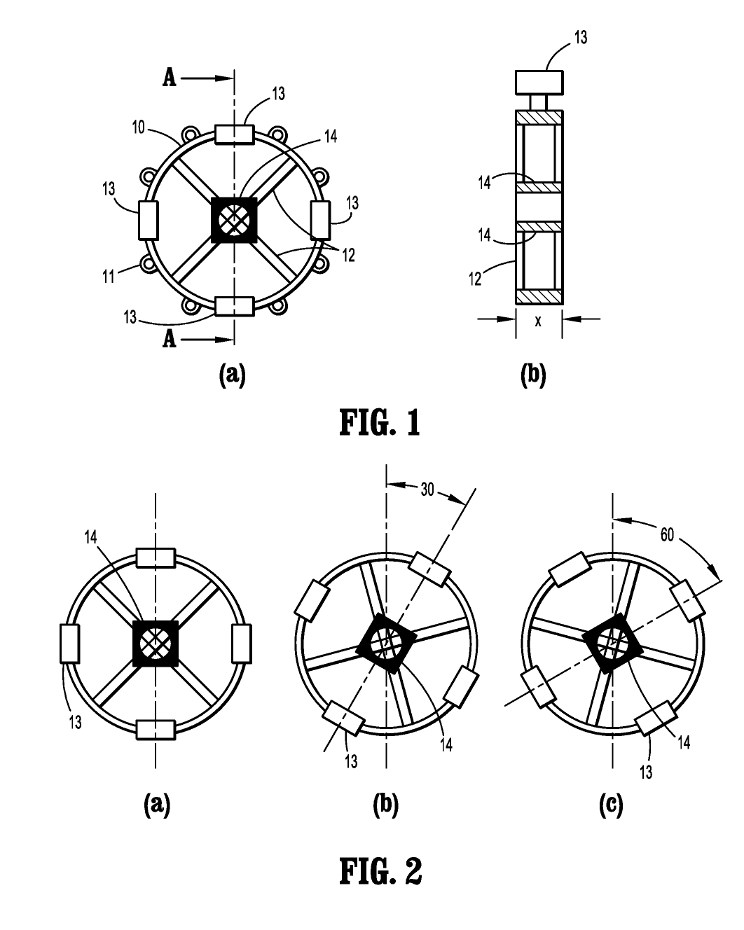

Embodiments of the current disclosure provide pipe with a circular cross section with transducers mounted on the circumference of the pipe and a reflector in the middle of the pipe. The reflector can be any shape that provides orthogonal surfaces which the acoustic wave can be reflected. For example, for a 4 transducers system, the reflector can be a square, an I beam, or a “+” shape in the middle. The choice for these surfaces should be selected for ease of manufacturing and assembly. In alternative embodiments, the configuration can be reversed, where the transducer is mounted inside, and the reflective surfaces on the outside. The number of transducers used depends on the desired coverage and flowrate. For illustrative purposes, a 4 transducer system is shown in FIGS. 1 and 2. It is expected that larger diameter pipes will require more transducers to ensure sufficient coverage.

These sectional modules can be fabricated independently, but during assembly of the system, each section can be rotated by a specified angle such that the acoustic field can cover the entire cross section. To enhance performance, these sections can also be separated by flow conditioner sections, where the flow can be manipulated to be presented to the acoustic field in the most favorable manner. This flow manipulation may include slowing or accelerating certain flow sections, or creating turbulence or other flow patterns to enhance the removal or separation of the phases in the flow. Computational fluid dynamics can be used to optimize the design of these flow condition sections.

Beyond providing a cost-effective system for second phase removal, this design is highly flexible and reduces the need for unique part numbers since the primary sections are interchangeable. These sections can be assembled together with flow conditioners for optimum performance. Certain judicials can be added to each section to improve ease of assembly and enhance the rotation. This may include special radial markings or flanges at specific radial angles. This design also allows higher volume production of individual modules.

FIG. 1(a) is a cross-sectional view of a stackable acoustic treatment module according to an embodiment of the invention, and FIG. 1(b) is a planar view along section AA of FIG. 1(a). Referring now to FIGS. 1(a) and (b), an exemplary, non-limiting stackable acoustic treatment module includes a segment of a circular pipe 10 on the outer wall surface of which are positioned four individually controlled ultrasound amplifiers and transducers 13 separated by 90°. Each ultrasound amplifier-transducer has a thickness x, as indicted in FIG. 1(b). Although only four ultrasound amplifiers-transducers are shown in FIG. 1(a) for clarity, embodiments are not limited to four ultrasound amplifiers-transducers, and in general n ultrasound amplifiers-transducers may be positioned on the circumference of a circular pipe, for a positive integer n, separated by an angle of

$$\frac{360 °}{n}$$

degrees, or

$$\frac{2 π}{n}$$

radians. The exemplary stackable acoustic treatment module shown in FIGS. 1(a) and (b) also includes a reflector unit 14 positioned at a center of the pipe that includes four individual reflectors, one opposite each ultrasound amplifier-transducer. Although FIG. 1(a) shows a reflector unit with a square cross section, other exemplary embodiments may include differently shaped reflector units. For example, the reflector unit could have an “I” beam or a “+” cross sectional shape. In general, an exemplary reflector unit will have a reflector for each ultrasound amplifier-transducer positioned opposite the respective ultrasound amplifier-transducer. Furthermore, in general, a reflector unit will have a cross section of a regular, convex, n-sided polygon. In addition, the exemplary stackable acoustic treatment module includes flanges 11 with holes or other fiduciary markings on the outer surface of the pipe for alignment and tightening sections that contain the amplifier-transducers, and a support structure 12 that supports the reflector unit. The support structure includes a plurality of struts. Although the figures depicts 4 support struts at right angle to each other, embodiments are not limited to four support struts, and in general n support struts may be used. In an exemplary embodiment, the number of support struts corresponds to the number of ultrasound amplifiers-transducers.

FIGS. 2(a)-(c) illustrate the rotation of modules to maximize acoustic field coverage, according to an embodiment of the invention. In particular, FIGS. 2(a)-(c) depict a three layer acoustic treatment module, in which each layer includes four ultrasound amplifier-transducers separated by 90°, the layer of FIG. 2(b) is rotated 30° with respect to the layer of FIG. 2(a), and the layer of FIG. 2(c) is rotated 60° with respect to the layer of FIG. 2(a). In this embodiment of four ultrasound amplifier-transducers separated by 90°, a fourth layer rotated by 90° would simply be a repeat of the first layer. A plurality of these three layer acoustic treatment modules can be stacked to maximize the coverage of the acoustic field. More layers can be used for better coverage. Again, it to be understood that the offset angle of 30° is exemplary and non-limiting, and that in general the offset angle may be (360/(n×m))°, for a positive integer m, and that a pipe of acoustic treatment modules may include repeated stacks of m modules, each rotated by (360/(n×m))° from a preceding module. Note that m may or may not be equal to n. In forming a stack of acoustic modules, a length of each module may be determined so that the position of each transducer along the length of the stacked pipe segments corresponds to a location of maximum vibration amplitude along the pipe.

While the present invention has been described in detail with reference to exemplary embodiments, those skilled in the art will appreciate that various modifications and substitutions can be made thereto without departing from the spirit and scope of the invention as set forth in the appended claims.

What is claimed is:

1. An acoustic treatment module, comprising:
a segment of a pipe;
a plurality of ultrasound amplifier-transducers symmetrically arranged on an outer circumference of the pipe segment; and
a reflector unit disposed in a center of the pipe segment and held in place by a support structure,
wherein said ultrasound amplifier-transducers are configured to emit ultrasound into the pipe segment while a fluid mixture is flowing therethrough, wherein a frequency of the ultrasound is configured to separate and coalesce particles from the fluid mixture.

2. The apparatus of claim 1, wherein the reflector unit includes a plurality of reflectors wherein each ultrasound amplifier-transducer has a corresponding reflector positioned opposite of the ultrasound amplifier-transducer.

3. The apparatus of claim 1, wherein the support structure includes a plurality of support struts wherein each ultrasound amplifier-transducer has a corresponding strut that connect the reflector unit to an inside surface of the pipe segment.

4. The apparatus of claim 2, wherein the reflector unit includes four reflectors, and the plurality of ultrasound amplifier-transducers includes four ultrasound amplifier-transducers.

5. The apparatus of claim 4, wherein the reflector unit has a cross sectional shape of a square.

6. The apparatus of claim 4, wherein the reflector unit has a cross sectional shape of a “+” sign.

7. The apparatus of claim 4, wherein the reflector unit has a cross sectional shape of an “I”-beam.

8. The apparatus of claim 1, further comprising a plurality of flanges configured to align and tighten sections containing the ultrasound amplifier-transducers.

9. The apparatus of claim 1, further comprising a stack of a plurality of acoustic treatment modules, wherein each acoustic treatment module is rotated with respect to a preceding acoustic treatment module wherein the ultrasound amplifier-transducers of each acoustic treatment module are offset by an angular separation with respect to the preceding acoustic treatment module that is less than an angular separation of the ultrasound amplifier-transducers on the acoustic treatment modules.

10. The apparatus of claim 9, wherein each acoustic treatment module includes four ultrasound amplifier-transducers with an angular separation of 90°, and each acoustic treatment module is rotated by 30° with respect to the preceding acoustic treatment module, and the stack of a plurality of acoustic treatment modules includes at least three acoustic treatment modules.

11. An acoustic treatment module stack, comprising:
a plurality of stacked pipe segments, wherein each pipe segment includes:
n ultrasound amplifier-transducers with an angular separation of (360/n)° on an outer circumference of the pipe segment, wherein n is a positive integer; and
a reflector unit disposed in a center of the pipe segment that includes n reflectors wherein each ultrasound amplifier-transducer has a corresponding reflector positioned opposite of the ultrasound amplifier-transducer;
wherein each acoustic treatment module is rotated (360/(n×m))° with respect to a preceding acoustic treatment module, wherein m is a positive integer, and the plurality of acoustic treatment modules includes at least m pipe segments.

12. The acoustic treatment module stack of claim 11, wherein the reflector unit is held in place by a support structure that includes a plurality of support struts wherein each ultrasound amplifier-transducer has a corresponding strut that connect the reflector unit to an inside surface of the pipe segment.

13. The acoustic treatment module stack of claim 12, wherein the reflector unit has a cross sectional shape of a regular, convex, n-sided polygon.

14. The acoustic treatment module stack of claim 12, further comprising a plurality of flanges configured to align and tighten the ultrasound amplifier-transducers.

15. The acoustic treatment module stack of claim 12, wherein the ultrasound amplifier-transducers are configured to emit ultrasound into each pipe segment while a fluid mixture is flowing therethrough, wherein a frequency of the ultrasound is configured to separate and coalesce particles from the fluid mixture.

16. An acoustic treatment module, comprising:
a segment of a pipe;
a plurality of reflectors symmetrically arranged on an outer circumference of the pipe segment; and
a plurality of ultrasound amplifier-transducers disposed in a center of the pipe segment and held in place by a support structure, wherein each ultrasound amplifier-transducer is positioned opposite from a reflector,
wherein said ultrasound amplifier-transducers are configured to emit ultrasound into the pipe segment while a fluid mixture is flowing therethrough, wherein a frequency of the ultrasound is configured to separate and coalesce particles from the fluid mixture.

17. The apparatus of claim 16, further comprising a stack of a plurality of acoustic treatment modules, wherein each acoustic treatment module is rotated with respect to a preceding acoustic treatment module wherein the reflector of each acoustic treatment module are offset by an angular separation with respect to the preceding acoustic treatment module that is less than an angular separation of the reflectors on the acoustic treatment modules.
